(19) United States
(12) Patent Application Publication
(10) Pub. No.: US 2006/0261607 A1
(43) Pub. Date: Nov. 23, 2006

(54) Security seal with peel off label

(76) Inventors: Joseph S. Kromkowski, Granger, IN (US); Thomas J. Hayes, Fort Wayne, IN (US)

Correspondence Address: VAN DYKE, GARDNER, LINN AND BURKHART, LLP, 2851 CHARLEVOIX DRIVE, S.E., P.O. BOX 888695, GRAND RAPIDS, MI, 49588-8695, US

(21) Appl. No.: 11/273,881

(22) Filed: Nov. 15, 2005

Related U.S. Application Data
(60) Provisional application No. 60/682,514, filed on May 19, 2005.

(51) Int. Cl. G09F 3/03

(52) U.S. Cl. 292/315

(57) ABSTRACT

A locking device or security seal includes a locking element, a locking body and a label adhesively applied to a surface of the locking body. The locking body is configured to receive an end of the locking element therein to secure the security seal at an object. The label has indicia formed therethrough and the locking body has the same indicia formed in its surface via a laser etching process. The label is removable from the surface of the locking body and is applicable to a tracking form to record identifying indicia of the security seal. The laser beam may be selected to selectively burn through the label material and at least partially into a non-metallic material of or at the surface of the locking body, without substantially burning into the locking body, such as into a metallic locking body or into a non-metallic or polymeric locking body.

### CROSS REFERENCE TO RELATED APPLICATION

The present application claims benefit of U.S. provisional application, Ser. No. 60/682,514, filed May 19, 2005 by Kromkowski et al. for SECURITY SEAL WITH PEEL OFF LABEL, which is hereby incorporated herein by reference in its entirety.

### FIELD OF THE INVENTION

The present invention relates to locking devices or security seals for locking or sealing items, such as cargo containers or doors or the like, and, more particularly, to a security seal with identification thereon and a method of labeling and tracking a security seal.

### BACKGROUND OF THE INVENTION

It is known in the art to provide a security seal or locking device for locking or sealing an item, such as cargo containers or doors or the like. The locking devices often include a flexible cable or bolt or the like extending from one end of a metallic or plastic locking body, where the cable or bolt or the like may be routed through an opening of the cargo container or door and received into another end of the locking body to substantially seal or secure the locking device to the cargo container or door. The locking devices are typically labeled during manufacturing of the locking devices, such as by etching or printing identification numbers or indicia on each locking device. When the locking devices are secured to the container or door, the numbers or indicia are written down on shipping or tracking documentation or paperwork to track the locking devices and containers, such that a person can later check the identification number or indicia to make sure that the same locking device is still on the container or door. The recordation of the identification numbers often takes place at a shipping yard or dock and may take place in adverse weather conditions. Sometimes, the numbers or indicia (which may be several numbers or characters) may be erroneously recorded on the shipping or tracking documentation, resulting in delays at the shipping or receiving facility, confusion and additional work and paperwork to determine the error and correct the error.

It has been proposed to record the identification of the locking devices via scanning a barcode on the security seal. While such an approach may reduce the errors in recordation of the identification, the barcode scanning and recording equipment is costly and some facilities do not have barcode capability and some environments are not suitable to the use of barcode scanning and recording equipment.

### SUMMARY OF THE INVENTION

The present invention provides a security seal or locking device, such as a cable security seal or locking device (or a bolt type security seal or other metallic or plastic locking devices or seals or lock bodies) that has a metallic locking body, which receives a cable therein to secure the seal to a container or door. An adhesive label is applied to the locking body, and an identification number or indicia is established through the label and into the surface of the locking body via the same or common process, such as via a laser cutting or establishing process. The label may then be readily removed from the security seal after the seal is secured to a container or door, and may be readily applied or adhered to the shipping or tracking documentation or paperwork or form. Thus, errors in recording the identification numbers or indicia are limited or substantially precluded.

According to an aspect of the present invention, a locking or sealing device includes a locking element (such as a flexible metallic woven cable or the like or such as any other flexible or rigid locking element or rod or the like, and such as a metallic or plastic locking element) and a locking body. The locking body is configured to receive an end of the locking element therein to lock or seal or secure the locking device at an object. A label is adhesively applied to the locking body, and identification numbers or indicia are established through the label and into the surface of the locking body via a laser etching or burning process. The label may be readily removed from the locking body and adhesively applied to shipping or tracking documentation to track or identify the security seal with respect to the object or container or door to which it is secured.

The locking element may comprise a flexible cable, with one end of the flexible cable being fixedly connected to a fixed portion of the locking body and extending therefrom, and the other end of the flexible cable being received in a locking portion of the locking body to lock or seal the locking device at the object. Alternately, the locking element may comprise a rod or bolt or other rigid or flexible locking element, and may comprise a metallic or elastomeric or plastic material. The locking body may comprise a metallic material (and may be coated with a polymeric or plastic or polyester coating or powder coat) or may comprise a polymeric or plastic material.

According to another aspect of the present invention, a method of identifying and tracking a security seal includes providing a locking element and providing a locking body for at least partially receiving an end of the locking element. A label is adhesively applied to a surface of the locking body, and identification numbers or indicia are established through the label and into the surface of the locking body via a laser etching or burning process. The security seal is secured to an object and the label is removed from the locking body and adhesively applied to shipping or tracking documentation or paper or forms to track or identify the security seal with respect to the object or container or door to which it is secured.

Therefore, the present invention provides a locking device or security seal (such as a cable locking or sealing device) that has a identifying and tracking feature that facilitates accurate and substantially error-proof recording of identification numbers or indicia of the security seal on the corresponding tracking or shipping documentation. Because the label and locking body are marked or etched together at the manufacturing facility of the security seal, the security seal and label of the present invention may be implemented at any shipping or receiving facility, without requiring any special equipment at the facility. The present invention thus provides a low cost and effective label and process to reduce or substantially preclude erroneous recordation of identification numbers or indicia of security seals after the security seals are applied to objects.

These and other objects, advantages, purposes and features of the present invention will become apparent upon review of the following specification in conjunction with the drawings.

### BRIEF DESCRIPTION OF THE DRAWINGS

FIG. 1 is a plan view of a cable security seal in accordance with the present invention, with a break in the cable shown to indicate that the cable may be of various lengths;

FIG. 2 is a plan view of the other side of the security seal of FIG. 1;

FIG. 3 is a sectional view of the security seal taken along the line III-III in FIG. 1; and

FIG. 4 is a block diagram of a method of labeling and tracking a security seal in accordance with the present invention.

### DESCRIPTION OF THE PREFERRED EMBODIMENTS

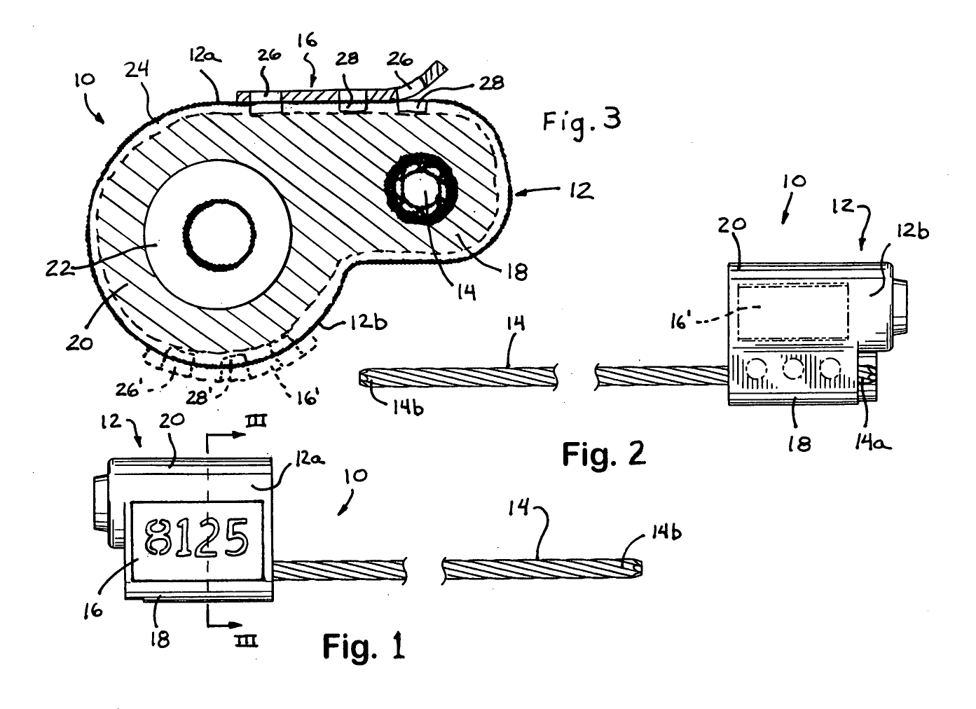

Referring now to the drawings and the illustrative embodiments depicted therein, a locking device or security seal 10 includes a metallic or elastomeric or plastic locking body 12, a locking element, such as, for example, a flexible locking element or cable 14, and a peel off label 16 that is adhesively applied to a surface 12a of locking body 12 (FIGS. 1-3).

Security seal 10 may be substantially similar to the locking device shown in U.S. Design Pat. application, Ser. No. 29/228,921, filed Apr. 29, 2005 by Beard et al. for CABLE LOCKING DEVICE (Attorney Docket BRA01 P-130), which is hereby incorporated herein by reference.

Cable 14 is fixedly secured at one end 14a at a fixed portion 18 of locking body 12 and extends therefrom. The cable 14 may be routed through a hasp or opening of an object (not shown), such as a cargo container or door latch or the like, and the opposite or locking end 14b of the cable 14 may be inserted into a receiving or locking portion 20 of locking body 12 to lock or seal the locking or sealing device 10 to the object. The label 16 is adhesively applied to surface 12a and identification numbers or characters or indicia are formed through the label and into the surface 12a of locking body 12 via a laser etching or burning process, as discussed below. Label 16 may be readily removed from locking body and applied to tracking or shipping documentation to accurately copy or record the identification numbers or characters or indicia of the security seal onto the appropriate documentation, as also discussed below.

Flexible locking element or cable 14 may comprise any cable or flexible element, such as a multi-strand cable that is woven from multiple metallic strands. For example, the cable 14 may comprise a multi-strand cable having multiple strands of wire woven or wound together, and then multiple woven strands may be further woven together to form the woven cable. The cable may comprise a pre-formed or non-preformed type of cable without affecting the scope of the present invention. The fixed end 14a of cable 14 is fixedly retained (such as via staking or welding or crimping or the like) at the fixed portion 18 of locking body 12 and extends therefrom. Although shown and described as a flexible cable, it is envisioned that the locking device may include a substantially rigid locking element, such as a substantially rigid locking rod or bolt or the like, without affecting the scope of the present invention. Alternately, other locking elements, such as rigid or flexible locking elements made of a metallic or elastomeric material, may be implemented with a plastic or metallic locking body, without affecting the scope of the present invention.

Locking body 12 includes a locking member or retaining element (not shown) within locking portion 20 of locking body 12 for receiving locking end 14b of cable 14 therein and substantially retaining locking end 14b therein so that removal of cable 14 and locking end 14b from locking body 12 is substantially precluded. The locking member may comprise a ball or disc or other locking member positioned within a tapered channel 22 within locking body 12, and may be biased toward the narrow end of the channel via a biasing element or spring or the like (also not shown), such as is known in the security seal art. Examples of suitable locking members or retaining elements are described in U.S. Pat. Nos. 6,578,886; 6,457,754; 5,611,583; and 5,352,003, U.S. patent application, Ser. No. 11/053,503, filed Feb. 8, 2005 by Beard et al. for NON-FERROUS CABLE LOCKING DEVICE (Attorney Docket BRA01 P-128), U.S. provisional applications, Ser. No. 60/664,069, filed Mar. 22, 2005 by Littrell et al. for CABLE LOCKING DEVICE WITH BREAKAWAY COVER (Attorney Docket BRA01 P-129), and PCT Application No. PCT/US2004/037838, filed Nov. 12, 2004 (Attorney Docket BRA01 FP-125(PCT)), which all are hereby incorporated herein by reference. However, other metallic or polymeric locking elements or members may be implemented with the locking body, without affecting the scope of the present invention.

In the illustrated embodiment, locking body 12 comprises a metallic material, such as aluminum or steel or the like, and includes a coated exterior surface 12a comprising a coating material or layer 24, such as a powder coat layer 24, such as a layer of a non-metallic powder coat material, such as a polymeric or plastic powder coat material, such as a polyester powder coat material or the like, is established at the surface 12a of locking body 12. Although shown as being a substantially thick powder coat layer in FIG. 3, this is shown for clarity purposes only. In practice, the powder coat layer may be a substantially thin layer at least partially over the surface of the locking body.

The label 16 is preferably adhesively applied or attached to surface 12a of locking body 12 to retain the label at the locking body. The label may include an adhesive layer, such as a pressure sensitive adhesive or other adhesive material. Label 16 may comprise a flexible substrate comprising a durable, polymeric material, such as a polyester or polyethylene material or the like, such as TYVEK® (commercially available from DuPont) or other suitable material. Optionally, the label 16 may be colored such that, when applied to a white or substantially white shipping form, the indicia formed through the label are visible as white indicia on the white form and are outlined by the colored material of the label so that the indicia are readily discernible and readable.

After label 16 is applied to surface 12a, a laser is used to cut or etch or burn through the label 16 and through or partially through the powder coat 24 of locking body 12 to establish the desired or appropriate identification numbers or characters or indicia 26, 28 at the label and locking body, respectively. Preferably, the laser is selected to burn through the materials of the label and the powder coat or surface layer 24 of the locking body, without substantially burning the metallic locking body. For example, a carbon dioxide (CO₂) laser is desirably used to mark through the applied adhesive-backed polyester label 16 and the polyester powder coat 24 on the metal locking body 12. The CO₂ laser removes, or “evaporates” plastic or polymeric materials that the laser beam is exposed to, and thus removes or evaporates the label and the powder coat in the areas that the laser is directed to, without burning or etching into the metallic locking body. Optionally, a YAG (yttrium aluminum garnet) laser or other suitable laser may work in the same way as a CO₂ laser by burning through the label and into the plastic substrate or layer at the locking body, thereby leaving a mark of a contrasting color in the plastic substrate or layer that is readily discernible after the etched label is removed (such as due to a contrast between the exposed metallic locking body and the plastic coating or substrate or due to a discoloration of the plastic coating or substrate during the laser etching or burning process).

Using a marking CO₂ or YAG laser (or other suitable laser) that is programmed to print or burn or evaporate or otherwise form or establish characters or graphics on the powder coat surface of the metallic locking body with the applied self-adhesive backed polyester label results in the indicia or pattern being etched through the label and also being etched through the powder coat surface of the metallic locking body (or at least partially etched or burned into or through a plastic substrate of a locking body or of a plastic locking body, as discussed below). The width of the etched material will be approximately the width of the laser beam. Optionally, the width of the etched characters or indicia can be widened by bringing the laser slightly out of focus, which results in a larger laser “dot” size.

The etched label, when removed from the powder coated locking body or plastic substrate, has the appearance of a “stencil”. Desirably, a special font with special “gaps” or “breaks” in the printed characters (such that the characters provide connection from the surrounding label material to any center portion of the character (such as to the interior portions of an “8” or the like and such as shown in FIG. 1)) allows for the removed label to retain the center of characters that may otherwise be left behind on the powder coated surface of the metallic locking body or on a polymeric or plastic locking body. The label thus may remain substantially continuous or un-broken and with no separated portions, such that when the label is removed from the surface of the locking body, the substantially continuous label leaves no portions of the numbers or letters or characters or indicia (such as, for example, the interior portion or portions of an “8” or “9” or “O” or “A” or “e” or the like) at the powder coat surface of the locking body. The label thus remains substantially intact and provides substantially the entirety of the numbers or characters, including interior portions thereof, when applied to the shipping or tracking document.

The label 16 may be applied to a substantially flat or planar surface 12a of locking body 12 (as shown in FIGS. 1 and 3). Optionally, however, and since the laser etching or forming process does not require physical contact with the label and locking body during the etching/forming process, a label 16′ may be readily applied to and the numbers or characters or indicia 26′, 28′ may be readily established at a curved surface 12b of the locking body (as shown in FIGS. 2 and 3).

After the label is applied to the locking body and the characters or indicia are formed or established through the label and the powder coat or plastic substrate or surface of the locking body, the security seal may be shipped or provided to a user at a shipping facility or the like. During use, the cable of the security seal (with the label applied to the locking body and the indicia established thereon) may be routed through an opening or hasp or the like of an object, such as a cargo container or door or the like, and the locking end of the cable may be inserted into the passageway of the locking or receiving portion of the locking body. When the cable is so inserted, the cable is retained in the locking body via the locking member or retaining element, such that the security seal is thus substantially locked or sealed to the object. Just prior to or when or after the security seal is attached or secured to the object, the label may be readily peeled from or removed from the locking body surface and adhesively applied to the shipping paperwork or documentation to provide an accurate recordation of the identification markings or characters or numbers or indicia of the security seal at the respective object. The locking device may be applied to a container or object and the label may be peeled from the locking device and applied to the shipping documentation at a shipping dock or other location of origin of the container. The shipping document (with the label thereon) may later (such as at the shipping destination of the object or cargo container) be readily compared to the locking device (with the indicia or markings established on the surface of the locking body) to confirm that the locking device was not removed or replaced or tampered with during shipping of the object.

Although shown and described as a security seal having a metallic locking body with an elastomeric or plastic over coat, the security seal may include a locking body that comprises an elastomeric material or other suitable material, without affecting the scope of the present invention. For example, the locking body may comprise a molded plastic locking body, and may be substantially uniformly molded or may be molded of different materials, as discussed below. The label may be adhered to the surface of the plastic locking body, whereby the laser functions to burn through the label (as described above) and partially into the plastic locking body. The laser may be selected and powered to provide the desired degree of burning into the plastic body to form the indicia at the surface of the plastic locking body and not substantially into the plastic locking body. Optionally, the locking body may include an additive that limits or partially or substantially blocks transmission of the laser beam, so that the laser beam does not penetrate substantially into the plastic locking body, but rather heats and burns or melts the outer surface of the locking body in the desired pattern. The power or intensity of the laser beam may also be selected to set or establish the depth that the laser beam penetrates the locking body so as to heat or melt or burn the label and heat or burn or melt or boil only an outer surface of the plastic locking body.

Optionally, the locking body may be formed of a plastic or polymeric material and may have a plastic overcoated or overmolded layer over the body portion (such as in a similar manner as described above with respect to the metallic locking body and powder coat). The overcoat or overmold layer may comprise a different color or contrast color or appearance than the body portion, so that the indicia formed in the overcoat/overmold layer are readily discernible due to the contrast between the inner body color viewable at the formed indicia and the outer body color surrounding the indicia. The locking body thus may comprise or include a plastic or metallic substrate, and may comprise a flexible or rigid plastic or metallic substrate. The locking body may have a laser etched pattern or indicia on the plastic substrate, in which the laser leaves a mark or pattern in the plastic substrate that is readily discernible at the substrate surface after the laser etched label has been removed from the locking body.

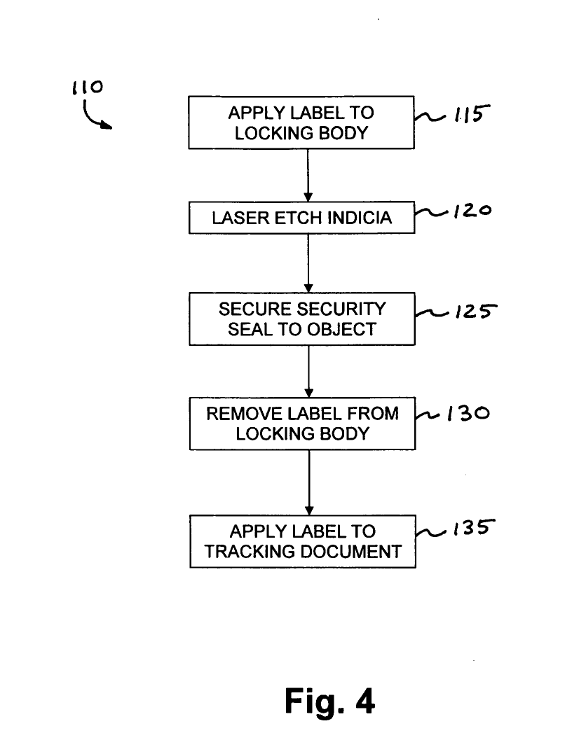

Referring now to FIG. 4, a process 110 for manufacturing and labeling a security seal and tracking the security seal at an object includes applying a label to a locking body of a security seal at 115. The appropriate or desired or selected numbers or characters or indicia or other markings are laser etched or burned through the label and also burned into and/or through a powder coat layer of the locking body at 120 or burned into or through a plastic substrate of the locking body or burned partially into a plastic locking body. The security seal is shipped or transferred to a shipping facility or the like and is secured to an object (such as a cargo container or door or the like) at 125. The label is removed from the locking body at 130, such as by peeling the label from the locking body (such as can be seen in FIG. 3).

The peeled off label is then applied or adhered to a tracking document (such as a shipping form or the like) at 135 to record the identification numbers or indicia of the security seal on the tracking document. The recorded identification numbers or indicia formed through the label on the tracking document may later be checked against the identification numbers or indicia formed on or into or partially through the locking body to ensure that the security seal was not removed and replaced during shipping and/or storage of the object. Because the identification numbers or indicia on the label and the locking body are formed during the same laser etching process, the numbers or characters or indicia are identical, such that accurate recordation of the numbers or indicia on the tracking documents is substantially guaranteed.

Although shown in a particular sequence in FIG. 4, clearly, the process for manufacturing and labeling a security seal and tracking the security seal at an object may be performed in other sequences, without affecting the scope of the present invention. For example, after the label and/or coating is applied to the locking body and the indicia are laser etched through the label and onto or into the locking body, the label may be removed from the locking body and the security seal (with the label removed therefrom) may then be sealed or attached to the object to secure or seal the object. The label thus may be removed from the locking body before the security seal is attached to the object, whereby the removed label may be applied to the tracking document before or around the same time as or after the security seal is sealed or attached or secured to the object. Preferably, the security seal is placed at and/or sealed to the object soon or substantially immediately following removal of the label from the locking body (and preferably the label is likewise applied to the tracking document in a similar timely manner), in order to limit or substantially preclude a mis-match between the label applied to the tracking document and the security seal at the object.

Therefore, the present invention provides a locking device or security seal that has a label adhesively applied to a locking body, whereby the identification indicia of the security seal is laser established through the label and through a powder coat layer on the locking body (or into a plastic locking body or into or through a plastic substrate or layer of a plastic or metallic locking body or the like) of the security seal during a single laser etching process. The laser beam is selected and the materials of the label and powder coat are selected so that the laser beam readily cuts or burns or evaporates the materials of the label and the powder coat (or other coating or material or body surface at which the label is adhered) without (or with minimal or reduced) cutting or burning or evaporating the metallic locking body or burning substantially into a plastic locking body or substrate. The label (with the indicia formed therethrough) is readily removed from the locking body and applied to a tracking document, whereby the identical tracking or identifying information (such as numbers, characters, indicia or the like) is on both the tracking document and on the security seal.

Changes and modifications to the specifically described embodiments may be carried out without departing from the principles of the present invention, which is intended to be limited only by the scope of the appended claims as interpreted according to the principles of patent law.

1. A security seal comprising:
a locking element, said locking element comprising one of a flexible cable and a substantially rigid rod;
a locking body, said locking body being configured to receive an end of said locking element therein to secure said security seal at an object; and
a label adhesively applied to a surface of said locking body, said label having indicia formed therethrough and said locking body having the same indicia formed in said surface via a laser etching process, said label being removable from said surface of said locking body and applicable to a tracking form to record identifying indicia of said security seal, said surface of said locking body having substantially identical indicia formed thereon as said label after said label is removed from said surface and applied to a tracking form.

2. The security seal of claim 1, wherein said locking body comprises a metallic material and said surface of said locking body comprises a non-metallic layer, said label comprising a non-metallic material, said laser etching process utilizing a laser beam that selectively burns said non-metallic material of said label and said non-metallic layer of said locking body.

3. The security seal of claim 2, wherein said laser beam does not substantially burn said metallic material of said locking body.

4. The security seal of claim 2, wherein said non-metallic layer comprises a polymeric layer and said non-metallic material comprises a polymeric material.

5. The security seal of claim 2, wherein said non-metallic layer comprises a polyester material and said non-metallic material comprises a polyester material.

6. The security seal of claim 2, wherein said laser beam comprises one of a carbon dioxide laser beam and a yttrium aluminum garnet laser beam.

7. The security seal of claim 1, wherein said locking body comprises a polymeric locking body, said laser etching process utilizing a laser beam that selectively burns said label and at least partially into said polymeric locking body.

8. The security seal of claim 7, wherein said laser beam burns a portion of said polymeric locking body to provide discernible indicia at the surface of said polymeric locking body.

9. The security seal of claim 1, wherein said locking element comprises a flexible cable, one end of said flexible cable being fixedly connected to a fixed portion of said locking body and extending therefrom, the other end of said flexible cable being received in a locking portion of said locking body to secure said security seal at the object.

10. The security seal of claim 1, wherein said indicia is formed through said label such that said label remains substantially continuous, such that when said label is removed from said surface of said locking body, no substantial portions of the indicia remain at said surface of said locking body.

11. A method of forming and labeling a security seal and tracking and identifying the security seal, said method comprising:
providing a security seal having a locking element and a locking body for at least partially receiving an end of said locking element to secure said security seal to an object;
applying a label to a surface of said locking body;
forming indicia through said label and into said surface of said locking body via a common laser etching process;
securing said security seal to an object;
removing said label from said surface of said locking body; and
applying said label to a tracking document, said label on said tracking document and said surface of said locking body at the object having substantially identical indicia formed therethrough and thereon, respectively.

12. The method of claim 11, wherein said locking body comprises a metallic or polymeric material.

13. The method of claim 12 including coating said metallic or polymeric locking body with a polymeric material such that said surface of said locking body comprises a polymeric material.

14. The method of claim 13, wherein said label comprises a polymeric material, said laser etching process utilizing a laser beam that is selected to burn through said polymeric material of said surface of said locking body and through said polymeric material of said label.

15. The method of claim 14, wherein said locking body comprises a metallic locking body and said laser beam does not substantially burn said metallic material of said locking body.

16. The method of claim 14, wherein said laser beam comprises one of a carbon dioxide laser beam and a yttrium aluminum garnet laser beam.

17. The method of claim 13, wherein said polymeric material of said surface of said locking body comprises a polyester or similar material and said polymeric material of said label comprises a polyester material.

18. The method of claim 12, wherein said locking body comprises a polymeric material, said laser etching process utilizing a laser beam that is selected to burn through said label and partially into said polymeric material of said locking body.

19. The method of claim 11, wherein said locking element comprises a flexible cable, one end of said flexible cable being fixedly connected to a fixed portion of said locking body and extending therefrom, the other end of said flexible cable being received in a locking portion of said locking body to secure said security seal at the object.

20. The method of claim 11, wherein forming indicia comprises forming indicia through said label such that said label remains substantially continuous, such that when said label is removed from said surface of said locking body, no substantial portions of the indicia remain at said surface of said locking body.

21. The method of claim 11 including shipping the object and said security seal and later identifying said security seal by reviewing said tracking document with said label thereon at a receiving facility.

22. The method of claim 11, wherein the step of securing said security seal to an object is performed before said label is removed from said surface of said locking body and said label is applied to a tracking document.

23. The method of claim 11, wherein the step of securing said security seal to an object is performed after said label is removed from said surface of said locking body.
